(19) United States
(12) Patent Application Publication
(10) Pub. No.: US 2023/0093923 A1
(43) Pub. Date: Mar. 30, 2023

(54) DRY COATING AND SELF-STANDING LAYERS WITH ALIGNED PARTICLES

(71) Applicant: BATTRION AG, Dübendorf (CH)

(72) Inventors: Max KORY, Zuerich (CH); Martin EBNER, Küsnacht (CH)

(73) Assignee: BATTRION AG, Dübendorf (CH)

(21) Appl. No.: 18/059,478

(22) Filed: Nov. 29, 2022

Related U.S. Application Data
(63) Continuation of application No. PCT/EP2022/058824, filed on Apr. 3, 2022.

(30) Foreign Application Priority Data
Apr. 7, 2021 (DE) 10 2021 108 683.3

(51) Int. Cl. H01M 4/04; H01M 10/0525

(52) U.S. Cl. CPC H01M 4/0457; H01M 10/0525; H01M 4/0435

(57) ABSTRACT

A method of dry coating of surfaces of a carrier and/or of production of self-standing layers, especially for use in lithium ion batteries having improved properties, is proposed, wherein the coating is effected at least by means of a particle-comprising powder in the dry state, especially having a solvent content of less than 1% by weight, and alignment of the particles is conducted in order to reduce the ionic resistance of the powder layer. The alignment of the particles additionally comprises fluidization of the powder.

### CROSS REFERENCE TO RELATED APPLICATIONS

This application is a continuation of International Application No. PCT/EP2022/058824 filed Apr. 3, 2022, which designated the United States, and claims the benefit under 35 USC § 119(a)-(d) of German Application No. 10 2021 108 683.3 filed Apr. 7, 2021, the entireties of which are incorporated herein by reference.

### FIELD OF THE INVENTION

The present invention relates to a method of dry coating of surfaces of a carrier and/or of production of self-standing layers, especially of dry coating of surfaces of an electrode as carrier in the production of lithium ion batteries, and a corresponding dry coating apparatus.

### BACKGROUND OF THE INVENTION

The prior art, for example WO 2020/150254 A1, discloses a method of dry coating of surfaces, which is used in the production of battery electrodes. The powder applied comprises graphite particles that are rounded and are considered to be spherical in a rough approximation. Nevertheless, these particles generally have a longest axis and thus differ distinctly from an ideal spherical form. The reason why preference is generally often given to an approximately ball-shaped particle form is that ions that flow through the material past the graphic particles should cover minimum distances.

### SUMMARY OF THE INVENTION

It is an object of the present invention to propose a dry coating method or an apparatus for dry coating with which more defined coating is possible and with which, in particular, the performance of a battery can be improved.

The method of the present invention is used for dry coating of surfaces of a carrier, as required, for example, for dry coating of surfaces of an electrode in the production of lithium ion batteries. The process according to the present invention may additionally also be used for production of what are called self-standing layers, i.e. of layers that do not need a carrier and in which, for example, the powder used for the coating is utilized as binder, possibly with additions.

In both cases, according to the present invention, at least one surface of a carrier is coated with a powder including particles. The powder is in the dry state or has a solvent content of less than 1 percent by weight.

The powder may contain particles in platelet form, in which, for a majority of the particles, an ellipsoid approximating to the respective particle shape has two axes of similar length and one distinctly shorter axis.

The powder may contain spherical particles, in which, for a majority of the particles, an ellipsoid approximating to the respective particle shape has three axes of similar length.

The powder may contain acicular particles, in which, for a majority of the particles, an ellipsoid approximating to the respective particle shape has one long axis and two distinctly shorter axes.

The powder may, specifically in the case of battery production, for example, be a graphite powder. It is also conceivable that the powder includes different or at least one or two electro-chemically active materials as a mixture, e.g. Si/SiOₓ, materials for cathode production.

The carrier is either a film that is actually to be coated, for instance, a copper film or the like, in which case the layer applied is to adhere to and remain on the carrier, or is a transport carrier that merely carries and transports the layer in sections of the production process, but the layer produced is then parted from the carrier. In the case of manufacture of a self-supporting layer, the carrier may also be part of the transport device with which the coating is moved from one process step in the production to the next, for example, a roller.

Accordingly, it is a feature of the present invention that an alignment of the particles is conducted in order to reduce ionic resistance, for example, in the case of electrode production. In the battery industry, particles in platelet form are typically avoided for production of electrodes, since these become aligned parallel to the carrier in standard electrode production methods and have higher ionic resistance in vertical direction relative to the carrier than comparable electrodes with spherical particles. The present invention overcomes the technical prejudice that the use of spherical particles already sufficiently minimizes the distance travelled by the ions through the layer, and that alignment of the particles does not significantly affect the ionic resistance. The particles that are referred to as spherical in the battery industry are generally rounded, but rarely approach the ideal spherical form; instead, their shaping is more comparable with potato-shaped forms. Therefore, contrary to the prejudice mentioned, alignment of longitudinal axes of the particles is indeed possible. Moreover, it has been found that ionic resistance, contrary to expectation, can be noticeably altered, and can, depending on the embodiment, quite possibly be reduced in the region of about 20%.

The use of platelet-shaped particles rather than spherical particles can save costs and raw material in the manufacture of the particles. Basically, the present invention makes it possible to dispense with the use of such (approximately) spherical particles; since even platelet-shaped particles that have not been subjected to abrasive finishing to give round particles are thus suitable for dry coating of electrodes having low ionic resistance since they too can be aligned according to the present invention. The operation of abrasive finishing of the particles is generally costly and certainly causes a loss of material that is sometimes high, and so this additional effort can now be dispensed with in principle.

By virtue of the alignment, ions in the layer no longer have to cover such long distances around the particles as in a layer with non-aligned particles. As a result, when the present invention is used in battery production, it is possible to achieve much better performance properties of the battery:
Ionic resistance becomes lower.
Charging and also discharging times can be lowered by the shorter diffusion path length.
The occurrence of metallic lithium plating can be shifted to higher current densities.
On account of the low ionic resistance not achievable, the battery is heated to a lesser degree in the charging and discharging.
The lower evolution of heat also ensures a higher degree of safety.

In order to be able to better align the particles in the powder, i.e. to assist the alignment, according to the present invention, fluidization of the solid-state pelletized material is undertaken, by virtue of which the pelletized material takes on fluid-like dynamic properties that can simplify alignment of the particles. The fluidization may especially be effected before and/or during the alignment, meaning that fluidization and alignment may especially also overlap in time. The interactions between the particles, the cohesion strength, are lower to a certain degree. The fluidization implements the transition from sticking friction to sliding friction as per what is called the stick-slip effect. The movement and rotation of the particles thus costs less energy. The friction forces on relative movements of the particles become less. It is thus also possible in an advantageous manner to increase the degree of alignment of the particles. The cohesion strength, which gives information about flow characteristics of the powder, can be determined with a powder rheometer.

Fluidization can be implemented by means of various working examples:

In one embodiment of the present invention, the powder and/or the carrier, and with it the powder present thereon, is subjected to a vibration or mechanical oscillation. This implementation can be undertaken in a relatively simple manner and without great costs, for instance, by using an ultrasound source. It is additionally independent of, for example, electrical or magnetic properties of the particles.

In order to perform contactless or essentially contactless alignment, the powder layer may be exposed to a force field, such as an electromagnetic field. In one execution variant of the present invention, the layer is in a magnetic field, while an AC voltage is simultaneously applied to the layer, for example, by contacting the carrier at each of two or more mutually separated sites, for example, in transport direction. The force that acts on the particles then arises by virtue of the Lorentz force.

A further option is to introduce a gas, for example, air, into the powder. This variant too is largely independent of electrical and magnetic properties of the particles.

Incidentally, the ultrasound source can also work without direct contact with the layer or carrier in that the ultrasound source subjects the layer or carrier to ultrasound in the manner of a loudspeaker and mechanical transmission takes place through the air.

Accordingly, it is a feature of a dry coating apparatus of the present invention that it, as well as a transport device (e.g. a conveyor belt as carrier or a conveyor belt for transport of a carrier, for example, a film) and an apparatus for coating of a powder onto a the carrier, for instance, a coating apparatus, an alignment apparatus is provided for alignment of the particles in order to be able to reduce the ionic resistance. In the case of electrode manufacture for batteries, it is surprisingly possible to further enhance the performance thereof even when rounded, virtually spherical particles are used. By virtue of the lower ionic resistance, the battery does not heat up so significantly. In addition, it is also possible to accelerate the charging and discharging operations since the migrating ions cover shorter distances. Incidentally, this can also increase the lifetime of the battery thus produced on average.

Rather than a conveyor belt or in addition to the conveyor belt, it is also possible to use a general conveying device, specifically when a self-supporting layer is to be produced. The powder may, for example, slide as pelletized material over a conveying device, similarly to a chute, and then be pressed between two rollers, for example, rotating in opposite senses, to give the later electrode.

By overcoming the prejudice that spherical particles have to be used, it is possible to save raw materials and costs.

In a preferred development of the present invention, this alignment of the particles is effected with the aid of a fluidization that can be implemented as described above.

If a voltage has to be applied to the powder layer, this can be effected, for example, by means of guide elements such as rollers, over which the carrier or film is guided. It is thus advantageously not necessary to provide an additional contact which engages with the film increases mechanical resistance, scratches the film and, as an additional component, always implies a certain higher cost factor.

The application of the powder admixed with particles to the carrier or the coating may also be followed by compression of the powder, associated with consolidation of the layer, such that the layer does not become detached from the carrier and a stable self-standing layer is formed. The consolidation by compression can be effected during or after the alignment, preferably generally after the alignment, with assistance of particle orientation by continuation of the alignment operation during the compression, for example, by continuing to maintain an aligning force field in which the particles are present in the course of compression. This can increase the degree of alignment. The compression can be undertaken mechanically, for example by compression between two rollers. Compression with the aid of heat is also conceivable.

The fluidization may as function of the alignment apparatus or, for example, also be integrated as a function of the transport and storage device.

In order to increase the intrinsic integrity of the layer and/or the integrity of the composite of layer and carrier, in one working example of the present invention, it is likewise possible to add binders to the powder. Useful examples include polymers, such as polytetrafluoroethylene PTFE, polyvinylidene fluoride PVDF, styrene-butadiene rubber SBR, mixtures thereof or other polymer mixtures etc. When polymers are used, these may preferably also be fibrillated, for example, by grinding in a jet mill, such that a coherent composite exists, which can have a supporting effect even in alignment by virtue of the interaction.

In addition, it is also possible to add electrochemically inactive substances to the powder, such as conductivity additives, carbon additives, carbon black, carbon nanotubes, for extended functionalization.

In general, depending on the embodiment, the application may be assisted by substances such as binders, adhesives, for example, in powder form (e.g. PTFE, PVDF, SBR, each with or without solvent), or by measures such as mechanical action (for example, including heating, for instance, via heated rollers), electromagnetic radiation, infrared radiation or other types of action.

A measure used for the performance of an electrode may, for example, be the MacMullin number. The MacMullin number indicates the ratio of ionic resistance of an electrolyte-filled porous body to the ionic resistance of the electrolyte volume that occupies the same space without the porous body. The MacMullin number generally depends on the porosity and geometric structure of the pores of a porous body. In a preferred embodiment, the method leads to a reduction in the MacMullin number of at least 5%, preferably at least 10%, more preferably at least 20%. The experimental determination of the MacMullin number is described in the following publication: Johannes Landesfeind et al 2016 J. Electrochem. Soc. 163 A1373 https://dx.doi.org/10.1149/2.1141607jes.

The degree of alignment can be determined, for example, as follows: electrode cross sections can be created, for example, by means of separation methods, preferably by means of broad ion beam milling (BIB). Images of the cross sections can be created, for example, by means of electron microscopy, such that individual particles can be seen within the coating, especially such that a longest axis of the visible cross section can be determined for a number of particles, particularly advantageously such that it is also possible to determine a measure of particle size for these particles, for example, the cross-sectional area. It is possible to fix a particular number of particles to be examined, e.g. 100 particles, which are sorted, for example, descending by size of the cross-sectional area. For these particles, it is possible to ascertain the angle of the longest axis of the particle cross section and transport direction. The ratio of the number of particles, the longest axis of which has angle between 60° and 90° relative to transport direction, to the total number of particles considered is called degree of alignment (DoA). In a preferred embodiment, the degree of alignment (DoA) is at least 10%.

It is possible to divide cross sections of the coated carrier into one or more regions, for each of which the degree of alignment is determined. It is possible with preference to divide cross sections into a first region and a second region. The first region may, for example, be close to the carrier and may comprise, for example, one third or half of the coating thickness. The second region may, for example, be removed from the carrier, close to the coating surface, and may comprise, for example, one third or half of the coating thickness. More preferably, the first and second regions are of similar size. Preferably, the first and second regions together comprise an extensive number of particles considered, e.g. >50% of all particles considered.

In a preferred embodiment, the degree of alignment of the first region and the degree of alignment of the second region are similar, and preferably have a variance of <10%, more preferably <5%.

In a further preferred embodiment, the degree of alignment of the first region and the degree of alignment of the second region are dissimilar, and preferably have a variance of >10%, more preferably >50%.

The quality of alignment can be examined by means of x-ray diffraction (XRD), for example, by means of x-rays from an x-ray source with a copper anode having wavelengths of about 1.54 Angstroms. It is possible to measure the intensity of the reflected or transmitted x-radiation in an angle-dependent manner in order to establish a diffraction pattern. The diffraction pattern may contain reflections associated with planes of substances in the x-ray beam (e.g. crystal planes of crystals), for example, with crystal planes of graphite particles within the coating. Crystal planes may be described by means of what are called Miller indices, e.g.: (100) plane. It is possible to define a measure of the intensity of the x-ray reflection of a crystal plane, for example, the integral of the reflected x-ray intensity in an angle range associated with the crystal plane. This measure is called reflectivity.

It is possible to combine crystal planes in groups, advantageously groups having certain commonalities in relation to the orientation of the crystal planes. For graphite, it is preferably possible to combine crystal planes to give planar crystal planes, advantageously a selection from the following (with stated angles based on copper anode radiation):
(002) with reflection at about 26.5°
(004) with reflection at about 54.7°
(006) with reflection at about 87.1°

It is possible with preference, for graphite, to combine crystal planes to give nonplanar crystal planes, advantageously a selection from the following (with stated angles based on copper anode radiation):
(100) with reflection at about 42.4°
(101)R with reflection at about 43.4°
(101)H with reflection at 44.6°
(110) with reflection at about 77.5°

It is possible to calculate the ratio of the sum total of the reflectivity of a selection of planar crystal planes and the sum total of the reflectivity of a selection of nonplanar crystal planes. This ratio is referred to as the orientation index (01). The orientation index is preferably calculated as the ratio of reflectivity of the (004) plane and the reflectivity of the (110) plane. In a preferred embodiment, the orientation index is at least 5, preferably at least 10, more preferably at least 20.

### BRIEF DESCRIPTION OF THE DRAWINGS

Working examples of the present invention are presented in the drawings and are elucidated in detail below with reference to further details and advantages. The figures specifically show:

FIG. 1 is a dry coating apparatus according to the present invention with magnet device within the storage roller;

FIG. 2 is a dry coating apparatus according to the present invention with magnet device within the conveying device;

FIG. 3 is a dry coating apparatus according to the present invention with a combination of vibration device and magnet device;

FIG. 4 is a dry coating apparatus according to the present invention with introduction of a gas into the powder layer;

FIG. 5 is a dry coating apparatus according to the present invention with ultrasound exposure;

FIG. 6 is a dry coating apparatus according to the present invention with a series of storage rollers;

FIG. 7 is a dry coating apparatus according to the present invention with compression of the powder layer; and

FIG. 8 is a schematic detail of a guide within a dry coating apparatus according to the present invention in the region of the alignment and fluidization via a Lorentz force.

### DETAILED DESCRIPTION OF THE INVENTION

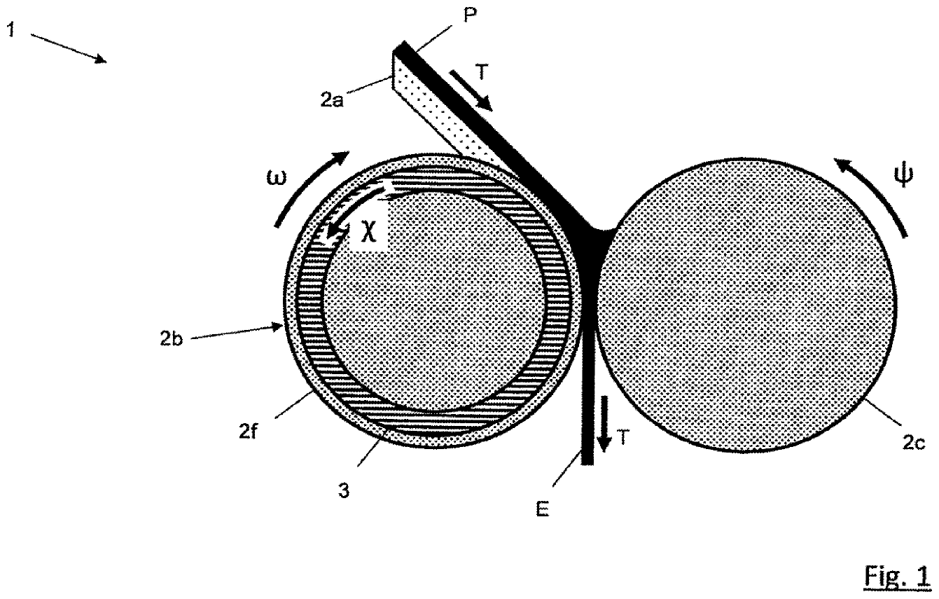

FIG. 1 shows a dry coating apparatus 1 with a conveying device 2a which is designed here as a slide and via which the powder P, which constitutes an accumulation of particles, is conveyed in transport direction T in the direction of two counter-rotating rollers 2b, 2c. The outer wall 2f of the roller 2b rotates with rotational speed ω and in the opposite sense to the roller 2c with rotational speed ψ. The powder P accumulates in the region in which the two rollers 2b, 2c, or the outer surface thereof, are close to one another. At the point exactly between the rollers 2b, 2c, and at which the rollers have the lowest separation, the instantaneous belt speed vectors each point in exactly the same direction T (downward in FIG. 1). The powder P is compressed there to give a self-standing layer, the electrode E to be manufactured. Within the roller 2b, concentrically relative to the outer ring 2f, is mounted a magnet device 3 as alignment apparatus, which rotates with speed of rotation χ in the same direction as roller 2c, i.e. in the opposite sense to the outer ring 2f. The magnet device 3 generates a magnetic alternating field in that the magnet ring 3 takes the form of an outward-facing Halbach cylinder, i.e. generates a strong magnetic field at the surface of the outer ring 2f and a temporally and locally varying field with the rotation of the magnet ring 3.

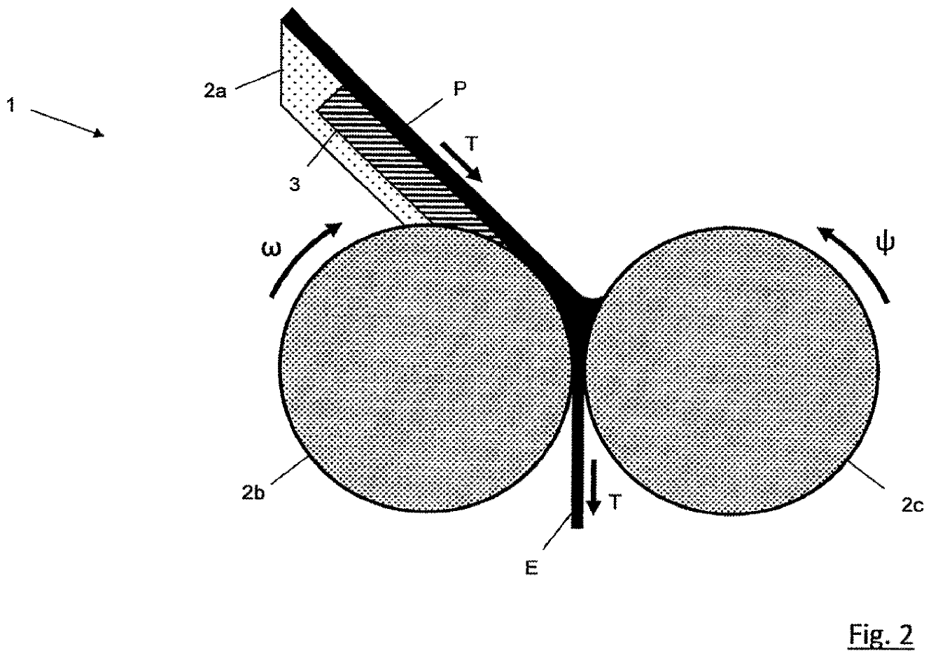

FIG. 2 shows a dry coating apparatus 1 of similar construction to that in FIG. 1, except that the alignment apparatus 3 is not integrated into one of the rollers 2b, 2c, which always rotate in opposite senses, but into the conveying device 2a. The magnet device 3 may also take the form of a Halbach array in order to generate a locally varying field. In this embodiment, the alignment force is low where the rollers 2b, 2c approach one another. It is, therefore, to be expected that the degree of alignment in this embodiment will be somewhat lower if anything.

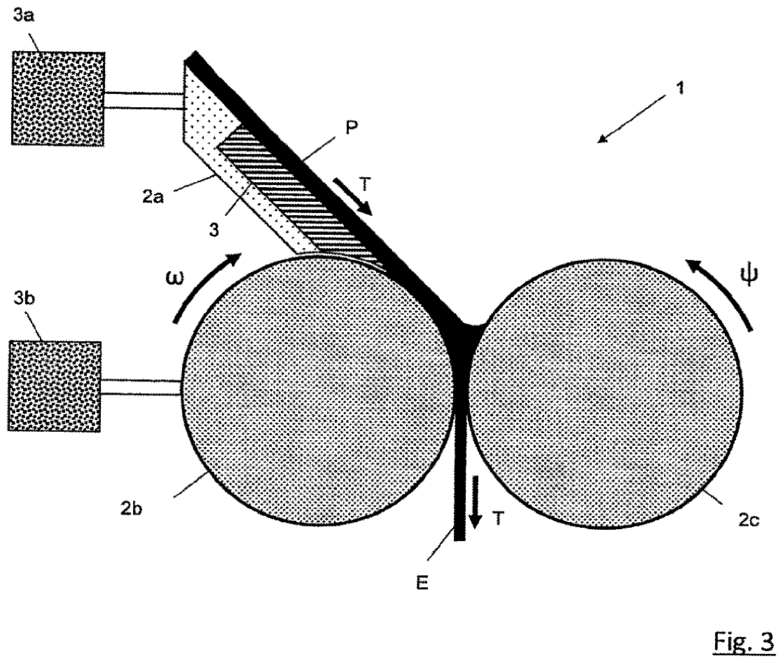

In FIG. 3, in turn, a combination of alignment apparatuses is used. Firstly, provided is a conveying device 2a (chute), via which the powder P moves in the direction of the counter-rotating rollers 2b, 2c. The powder P is compressed at the rollers 2b, 2c to give the self-standing electrode E without carrier.

In the conveying device 2a, the magnet device 3 in the form of a Halbach array generates a locally varying field with which particles in the powder P can be aligned while they are moving through the conveying device 2a.

For assistance of alignment, the powder P is fluidized in that a vibration device 3a is already coupled to the conveying device 2a, in order to set the conveying device 2a in a mechanical oscillation. The interactions between the particles become smaller, and these can additionally be oriented more easily via the magnet device 3 (as Halbach array).

For additional assistance of the alignment and fluidization, a further vibration device 3b is coupled mechanically to the roller 2b. This agitation effect which is caused by the roller 2b assists both the flow of the powder B and alignment.

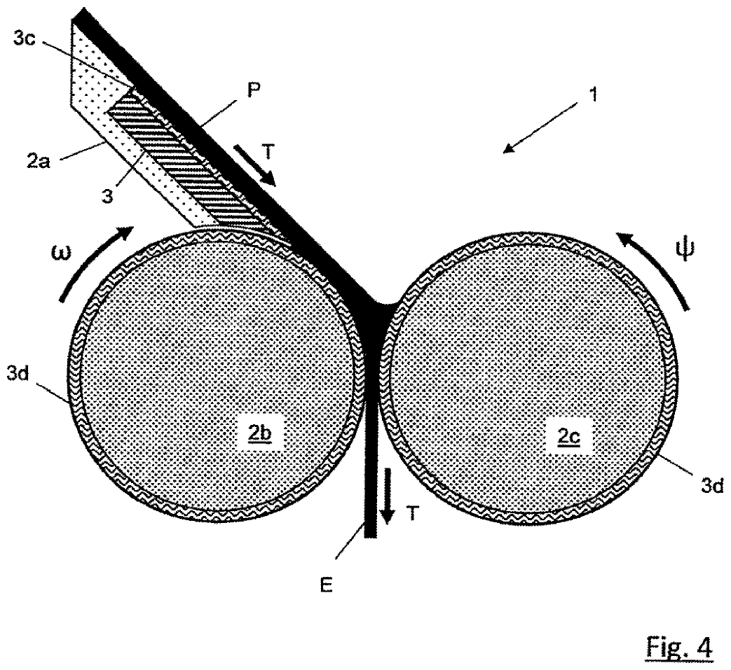

The fluidization may, as described above, also be achieved by means of a gas which is introduced into the powder P. Such a design is shown in FIG. 4. The basic construction with conveying chute 2a and two counter-rotating rollers 2b, 2c is in principle the same as described in the designs above. An alignment apparatus in the form of a magnet 3 is integrated into the conveying device 2a. Both in the region of the conveying device 2a and in the region of the rollers 2b, 2c, the surfaces that come into contact with the powder are formed from a porous material. From the side remote from the powder P, a gas is introduced onto this porous surface, and is let through by the surface specifically because of its porous structure and ultimately penetrates into the powder layer P. This powder layer P is fluidized and improves the flow characteristics thereof, which assists the alignment of the particles.

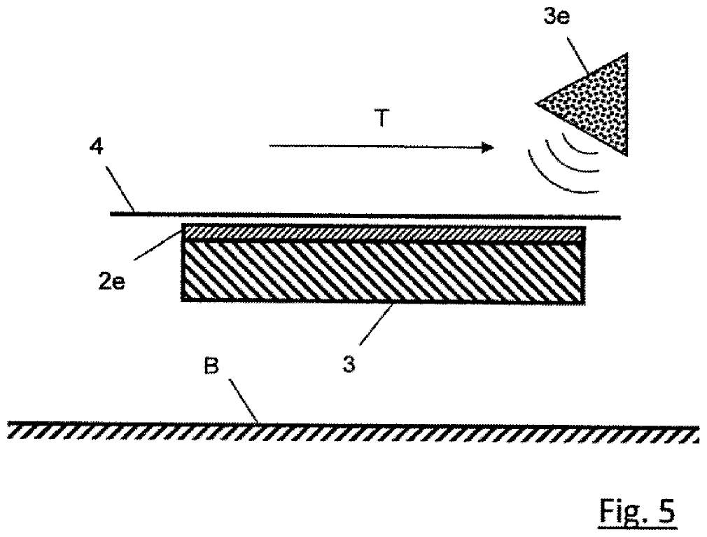

Another means of transmitting a mechanical vibration to the carrier or powder layer is shown in FIG. 5. The carrier 4 is guided over the base B by means of a gas bearing 2e on an air cushion. Beneath the gas bearing 2e is disposed a magnet device 3 for alignment of the particles. The powder P applied to the carrier 4 is fluidized by means of an ultrasound source 3e that transmits the sound waves that it has emitted through the air onto the powder P or the carrier 4.

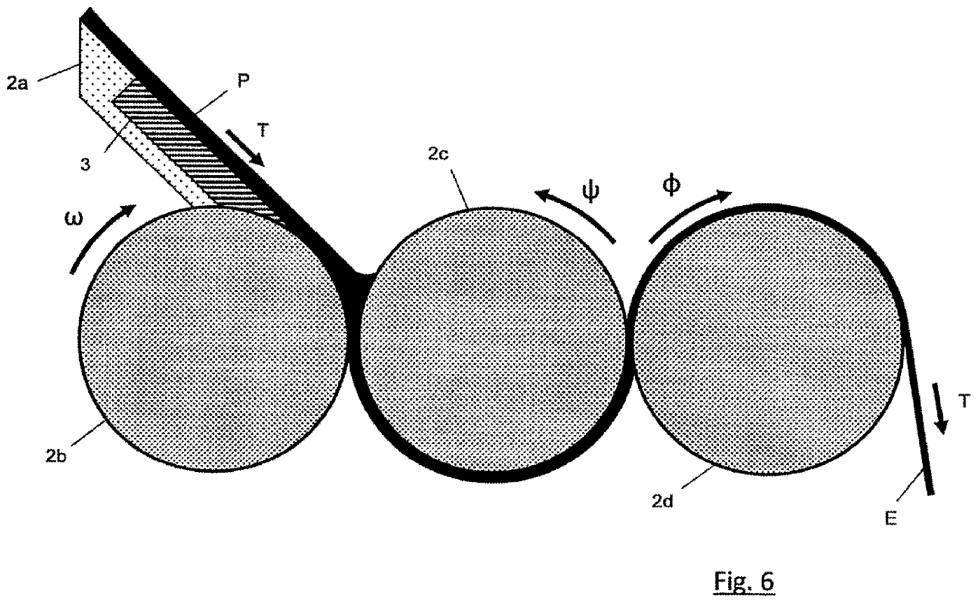

In the manufacture of the electrode E, for better control, particularly of the thickness of the electrode E, it is possible to provide a system of rollers 2b, 2c, 2d in series, as described in FIG. 6. Here too, the powder is compressed between the rollers 2b, 2c, and 2d. The gap between the rollers 2c, 2d is smaller than the gap between the rollers 2b, 2c, in order to be able to compress the layer more significantly and hence to make it thinner. The alignment of the particles is accomplished by means of a magnet device 3, which may likewise take the form of a Halbach array.

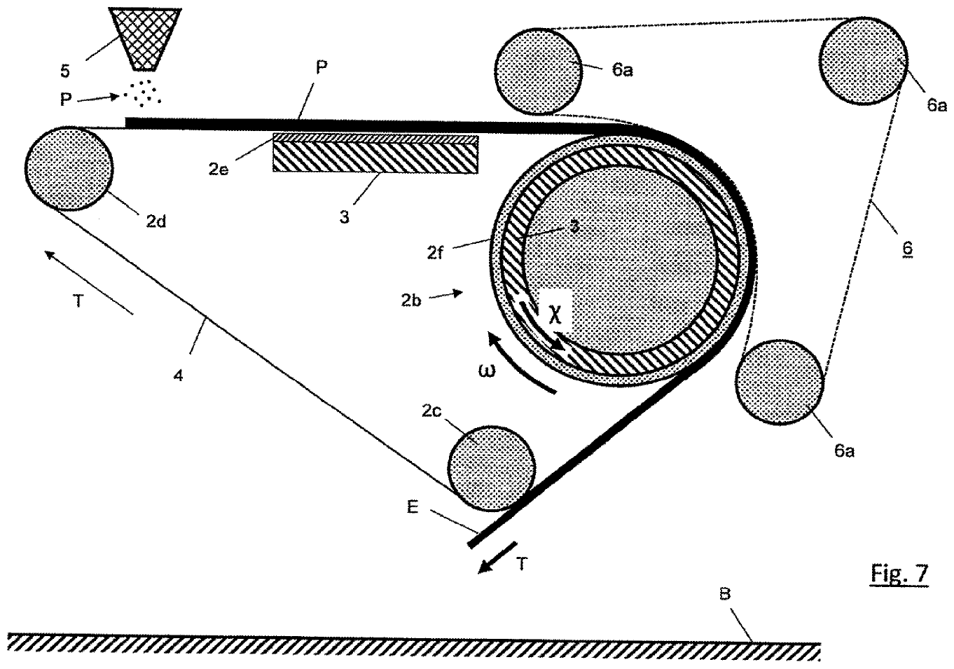

In FIG. 7, a revolving conveyor belt 4 is utilized, which is guided over the rollers 2b, 2c, 2d. The coating device 5 applies the powder P or the particles to the carrier belt 4. The coated carrier 4 runs over a gas bearing 2e which, toward the carrier 4, has a layer of porous material through which a gas/air flows out and forms an air cushion between carrier 4 and gas bearing 2e. Below the porous layer 2e is mounted a magnet device 3 (e.g. Halbach array), in order to act on the coating/the powder P. A further magnet device 3 (for example, in the form of a Halbach cylinder) is integrated into the roller 2b. The cylindrical magnet device 3 is in a coaxial arrangement with respect to the outer ring 2f. The two of these rotate in opposite senses. During the action of the cylindrical magnet device 3, the powder coating P is compressed by means of a press belt 6 which is run in a revolving manner on rollers 6a. For this purpose, the press belt 6 is pulled under tension against the coating P or against the carrier 4. In the region of the roller 2c, the electrode E can be detached in the region of an inflection in the transport pathway T.

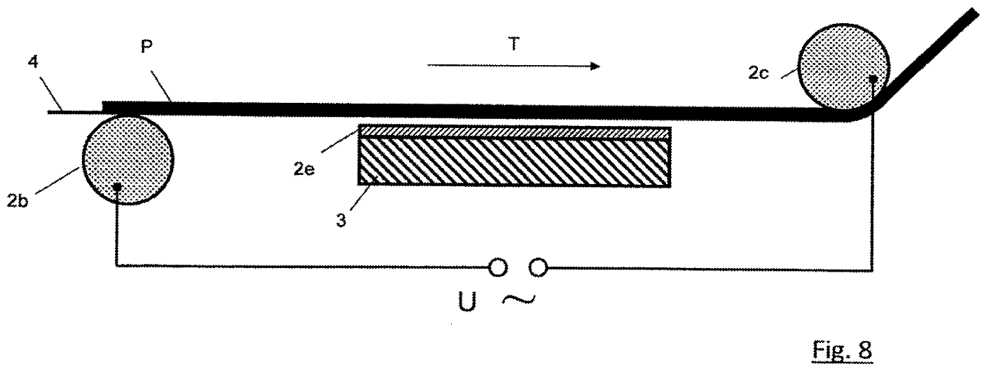

A further principle of fluidization is shown in schematic form in FIG. 8. A carrier 4 runs in transport direction T over two rollers 2b, 2c. The roller 2c is disposed on the on the opposite side in relation to the carrier 4 and the coating P and compresses the layer P. Between the rollers 2b, 2c is disposed a gas bearing 2e, i.e. the carrier 4 runs on an air cushion in this region. Beneath the gas bearing 2e is provided a magnet device 3, and the carrier 4 with the coating P (powder) applied thereto is exposed to the magnetic field therefrom. In addition, a voltage is applied to the coating P, which leads to a flow of current. A force acting on the particles in the coating P that leads to fluidization and assists the alignment of the particles is brought about by the resulting Lorentz force. The rollers 2b, 2c are electrically conductive in that, for example, the surface thereof that comes into contact with the carrier 4 is electrically conductive. The carrier 4 may likewise be electrically conductive; for example, in the present case, it may typically be a copper foil for production of electrodes of lithium ion batteries. The roller 2c is in contact with the coating P, such that current flows not only through the carrier 4/the copper foil.

Common factors in all working examples and developments of the present invention are that:
in the dry coating, an alignment of the particles is additionally conducted, for example, in order to reduce the ionic resistance of the powder layer in the case of a graphite coating for electrodes of a lithium ion battery. In an advantageous manner, the alignment of the particles can be assisted by fluidization of the powder, in that the interaction between the particles is reduced in the alignment of the particles, and
the alignment of the particles comprises fluidization of the powder (P) and/or fluidization is conducted before and/or during the alignment of the particles, which improves alignability, especially by reducing the mechanical interactions between the particles.

### LIST OF REFERENCE NUMERALS

1 dry coating apparatus
2a conveying device
2b, 2c, 2d roller
2e gas bearing
2f outer ring
3 magnet device
3a, 3b vibration device
3c, 3d porous material for introduction of gas
3e sound source
4 carrier
5 coating device
6 press belt
6a roller for press belt storage
B floor
E electrode
P powder
transport direction
U (AC) voltage source
ω speed of rotation
ψ speed of rotation
χ speed of rotation

1. A method of dry coating of surfaces of a carrier and/or of production of self-standing layers for use in lithium ion batteries, wherein
the coating is effected at least by means of a particle-comprising powder in the dry state, with a solvent content of less than 1% by weight,
wherein an alignment of the particles is conducted in order to reduce the ionic resistance of the powder layer, wherein
the alignment of the particles comprises fluidization of the powder and/or fluidization is conducted before and/or during the alignment of the particles, which improves the alignability by reducing the mechanical interactions between the particles.

2. The method according to claim 1, wherein the fluidization includes a method step:
in which the powder and/or the carrier is subjected to a vibration and/or to a mechanical oscillation, and/or
in which the vibration is caused by an ultrasound source, and/or
in which an electrical voltage is applied to the powder and/or the carrier, and it is simultaneously subjected to a magnetic field, and/or
in which a gas stream is introduced into the powder.

3. The method according to claim 1, wherein the coating of the surface and/or the application of the powder to the carrier is followed by compression of the powder, wherein the compression of the powder is effected by mechanical compression and/or under the action of heat.

4. The method according to claim 1, wherein a binder is added to the powder in order to improve the application to the surface and/or the integrity of the coating.

5. The method according to claim 1, wherein the carrier used is a conveyor belt and/or a film and/or a film transported on a conveyor belt.

6. The method according to claim 1, wherein the ratio of the number of particles that can be seen in a carrier cross section and have an angle between the respective longest particle axis that can be seen in cross section and transport direction of between 60° and 90° to the total number of particles that can be seen is at least 10%.

7. The method according to claim 1, wherein the ratio of the reflectivity of the (004) plane at about 54.7° to the (110) plane at about 77.5°, ascertained by means of x-ray diffraction with copper anode radiation having a wavelength of about 1.54 ångströms in the carrier produced is at least 5.

8. The method according to claim 1, wherein the MacMullin number of the carrier produced is at least 5% less than a comparable electrode having the same composition and same weight by surface area and same thickness that has been produced without the method.

9. A dry coating apparatus for dry coating of surfaces of an electrode as carrier in the production of lithium ion batteries, and for performance of the method according to claim 1, comprising:
a transport device comprising a conveyor belt and/or a conveying device as carrier and/or for transport of a film as carrier,
a coating device for application of the powder in the dry state, with a solvent content of less than 1% by weight, to the carrier,
wherein there is an alignment device for alignment of the particles, in order in particular to reduce the ionic resistance of the powder layer.

10. The dry coating apparatus according to claim 9, wherein the alignment apparatus and/or the transport device is set up for fluidization of the powder in order to reduce the interaction between the particles in the alignment of the particles, and for this purpose comprises:
a vibration device and/or an ultrasound source, in order to subject the powder and/or the carrier to vibration and/or mechanical oscillation, and/or
a magnet device, in order to subject the powder and/or the carrier to a magnetic field, and an AC current source, in order to apply an AC voltage to the powder, and/or
an apparatus for introduction of a gas into the powder.

11. The dry coating apparatus according to claim 10, wherein the transport device and/or at least one storage apparatus of the transport device comprises at least one roller, wherein
the at least one roller is/are each designed as an electrode for application of the voltage to the powder layer, and/or
at least one roller comprises an outer wall and a magnet device that are respectively mounted as a ring around the axis of rotation of the roller, with the outer wall in particular designed to rotate about the axis of rotation counter to the magnet device, and/or
the magnet device is designed as a Halbach cylinder.

12. The dry coating apparatus according to claim 9, wherein a compression apparatus for compression of the layer of powder on the carrier is provided, which comprises:
a driven roller by means of which the carrier is guided and/or can be guided, and/or
a press belt tensioned such that it pushes the carrier against the roller over a transport zone section, and/or
at least two rollers arranged so as to rotate in the opposite sense from the respectively adjacent rollers, in order thus to guide the carrier and/or the powder layer through their interspaces, and/or
an apparatus for the generation of heat.

13. A dry coating apparatus for dry coating of surfaces of an electrode as carrier in the production of lithium ion batteries, and for performance of the method according to claim 1.

14. An electrode for the production of lithium ion batteries, obtainable by a method according to claim 1, wherein the ratio of the number of particles that can be seen in an electrode cross section and have an angle between the respective longest particle axis that can be seen in cross section and transport direction of between 60° and 90° to the total number of particles that can be seen is at least 10%.

15. An electrode for the production of lithium ion batteries, obtainable by a method according to claim 1, wherein the MacMullin number of the electrode produced is at least 5% less than a comparable electrode having the same composition and same weight by surface area and same thickness that has been produced without the method.
